(19) United States
(12) Patent Application Publication
(10) Pub. No.: US 2006/0214395 A1
(43) Pub. Date: Sep. 28, 2006

(54) Child stroller with umbrella type folding

(75) Inventor: Laurent Ageneau, Pornic (FR)

Correspondence Address: WESTMAN CHAMPLIN & KELLY, P.A., SUITE 1400, 900 SECOND AVENUE SOUTH, MINNEAPOLIS, MN, 55402-3319, US

(73) Assignee: Dorel France SA, Cholet (FR)

(21) Appl. No.: 11/355,917

(22) Filed: Feb. 16, 2006

(30) Foreign Application Priority Data
Feb. 16, 2005 (FR) 05/01590
Jul. 13, 2005 (FR) 05/07564

(51) Int. Cl. B62B 7/00

(52) U.S. Cl. 280/642

(57) ABSTRACT

The invention relates to a stroller for a child including at least three blocks of at least one wheel, each mounted at a first end (111, 121, 131, 141) of an arm (11, 12, 13, 14), the second end of which is articulated and free to slide along a main beam (1). The arms (11, 12, 13, 14) are guided by at least one connecting rod between a folded position in which they form a small angle with the said beam (1), and an unfolded position in which the arms form an angle larger than the small angle.

The stroller according to the invention comprises at least one sliding element (42) mounted on the said beam (1), to which at least one of the said connecting rods is fixed, and suspension means (43) fixed to the said beam (1) and acting on at least one of the sliding elements (42).

### PURPOSE OF THE INVENTION

This invention is related to the puericulture field. More precisely, the invention relates to child carriages, and particularly folding mechanisms for such child carriages. Even more precisely, the invention relates to umbrella type folding strollers.

### PRIOR ART

Very many techniques are already known for folding of stroller frames. In general, the main purpose is to reconcile at least some of the following objectives:

folding efficiency, the overall dimensions of the folded stroller being as small as possible so as to facilitate its storage and transport, for example in an automobile vehicle;

simplicity of folding and unfolding manipulations, the user must be able to fold and unfold the stroller with a small number of operations and each of these operations should be as easy as possible;

safety of the transported child and particularly control of folding (to reduce unwanted folding, particularly in the presence of a child);

ease and low cost of manufacturing.

Obviously, it is also necessary that the stroller should be comfortable and safe for the child when in the unfolded position.

The different types of known frames include a technique consisting of articulating the front and back legs of the stroller on a main beam. By sliding these legs along the main beam, the legs are extended such that they pass from a folded position in which they are close to the beam, to an unfolded position in which they are at a variable angle from the main beam.

This technique, called the umbrella folding stroller (because it is based on the same principle as an umbrella), is described particularly in patent document U.S. Pat. No. 3,936,069. This stroller comprises a main beam that is proximately vertical, for which the upper end is fixed to a handlebar and the lower end supports an articulation element, on which legs are articulated. A rigid structure designed to support the child and supporting the articulations slides along the main beam. Therefore, this technique provides the means of extending the legs when the structure slides along the main beam, until the articulation elements stop in contact with the lower end of the rigid structure. The legs are folded by reverse manipulation of the beam.

This relatively old folding technique was not very successful for different reasons, and particularly the child's comfort.

Strollers are now designed for various uses (displacement in town, woods, countryside, etc.) and must be suitable for use on different types of ground. In particular, the comfort and safety of the transported child are not optimum when the ground is rough or if there are any holes or bumps. These strollers do not have any shock absorbing or suspension means.

Furthermore, the main beam designed to support the child induces a relatively large overall height, which is not what users want, they are particularly interested in the stroller being compact when in the folded position.

### PURPOSES OF THE INVENTION

The main purpose of the invention is to overcome these disadvantages according to prior art.

More precisely, one purpose of the invention is to provide such a stroller with good comfort and safety qualities, both for the transported child and for the person pushing the stroller.

Thus, one particular purpose of the invention is to provide such a stroller capable of damping and/or reducing shocks, particularly when the ground is more or less broken or degraded.

Another purpose of the invention is to provide such a stroller with a folding frame that is compact when in the folded position, particularly to enable easy transport and storage.

Another purpose of the invention is to provide such a stroller that is simple and ergonomic to fold and unfold.

Another purpose of the invention is to provide such a stroller that is easy and inexpensive to make and to assemble.

### ESSENTIAL CHARACTERISTICS OF THE INVENTION

These and other purposes that will become clearer later, are achieved by means of a stroller for a child including at least three blocks of at least one wheel, each mounted at a first end of an arm, the second end of which is articulated and free to slide along a main beam, the said arms being guided by at least one connecting rod between a folded position in which they form a small angle with the said beam, and an extended position in which the said arms form an angle larger than the said small angle. According to the invention, the stroller comprises at least one sliding element mounted on the said beam, to which at least one of the said connecting rods is fixed, and suspension means fixed to the said beam and acting on at least one of the said sliding elements.

The result is a stroller in which the arms can be efficiently folded and unfolded, based on a quite new approach to the connecting rods driving and synchronisation mechanism.

Therefore, the invention proposes a suspension system with movement along the main beam. The result is thus a more comfortable and particularly a more reliable stroller because it efficiently attenuates unexpected shocks due to rough ground.

In one preferred embodiment of the invention, the said suspension means comprise a coil spring mounted on the said main beam.

Advantageously, a first end of the said coil spring is fixed to one of the said sliding elements.

Preferably, a second end of the said coil spring is free.

According to one advantageous aspect of the invention, at least one of the said connecting rods is fixed to a sliding element and at least one of the said connecting rods is fixed to a fixed part installed on the lower end of the said beam.

Preferably, each connecting rod associated with a rear wheel is a first connecting rod and each connecting rod associated with a front wheel is a second connecting rod.

Advantageously, the stroller comprises means of locking in the extended position, comprising a locking pin cooperating with an opening formed in the said beam.

In one preferred embodiment of the invention, the said opening is a slit enabling a slight movement along the said beam.

Advantageously, the said main beam can be folded to reduce its size in the said extended position.

Preferably, the said main beam consists of a first element with guide means for a corresponding second element to slide in or close to the said first element.

Advantageously, the stroller comprises a seat support forming a connection between the said locking means and a sliding support of the said arms.

Preferably, the stroller includes means of controlling the said first locking means mounted on the said beam.

According to one advantageous aspect of the invention, the said seat support consists of two elements mounted articulated on the said sliding support such that they oppose opening of a hammock when they extend below the said sliding support.

In one preferred embodiment of the invention, the stroller comprises a hammock support formed from two longitudinal members, each formed from two sliding tubes, one sliding inside or relative to the other.

Preferably, at least one of the said sliding tubes is guided in sliding by a connecting rod.

Advantageously, the stroller includes a footrest formed from two articulated pallets.

Unfolding and/or folding of the said footrest is preferably controlled by at least one cable and/or at least one connecting rod.

According to one advantageous aspect of the invention, at least one of the said pallets supports at least one support element to hold the said stroller in the upright position, when it is in the folded position.

Preferably, each of the said pallets supports a support element, these support elements being mounted such that when they are in contact with the ground, they oppose unfolding of the stroller.

Advantageously, the said main beam is provided with means for guidance of the said stroller at its upper end, articulated with respect to the said main beam.

Advantageously, the said guide means comprise second locking means installed articulated on the said main beam such that when in the unlocked position, they enable rotation of the said guide means around an axis perpendicular to the said main beam.

Preferably, the said guide means comprise third locking means using a clutch mechanism, part of which is fixed to the main beam and another part of which is fixed to the guide means.

According to one preferred embodiment of the invention, the third locking means cooperate with the second locking means to immobilise the guide means with respect to the main beam.

The invention also relates to a child stroller frame as described above.

### LIST OF FIGURES

Other characteristics and advantages of the invention will become clearer after reading the following description of a preferred embodiment of the invention given as a simple illustrative example without being limitative, and the attached drawings among which:

FIG. 1 shows a back view of a stroller according to the invention in the folded position;

FIG. 2 shows the stroller in FIG. 1, in the extended position;

FIG. 3 shows the driving and synchronisation mechanism of the stroller in FIG. 2, in more detail;

FIG. 4 shows the control handle of the driving and synchronisation mechanism in FIG. 3;

FIG. 5 shows the handlebar of the stroller according to the invention in more detail;

FIG. 6 shows the footrest of the stroller according to the invention in more detail;

FIGS. 7A and 7B show a stroller according to the invention, in the folded and non-folded positions respectively;

FIG. 8 shows the articulation structure according to the invention in more detail;

FIG. 9 shows the hinged part according to the invention in more detail;

FIG. 10 shows the stroller handlebar in FIGS. 7A and 7B in more detail; and

FIGS. 11A and 11B are diagrammatic views showing the front view of one variant arrangement of the stroller mechanism;

FIG. 11A: in the folded position;

FIG. 11B: in the extended position.

FIG. 12 shows a variant embodiment of the handlebar inclination control mechanism for the stroller in FIG. 1, using a clutch mechanism;

FIGS. 13A and 13B show another variant embodiment of the mechanism controlling the inclination of the stroller handlebar in FIG. 1, combining a clutch and a cam:

FIG. 13A: mechanism with clutch in the locked position;

FIG. 13B: mechanism with clutch in the unlocked position.

### DESCRIPTION OF AN EMBODIMENT OF THE INVENTION

Therefore, the invention relates to an improvement to umbrella type folding strollers.

According to the invention, the driving of the front and back legs is controlled by two separate elements mounted on the main beam, instead of being controlled by a single element as is the case for known strollers of this type (and similarly in umbrellas). Advantageously, a suspension spring is provided.

Thus, a spring may be used particularly as a central suspension. The result is a very efficient stroller combining comfort and safety of the transported child, even on poor ground surfaces.

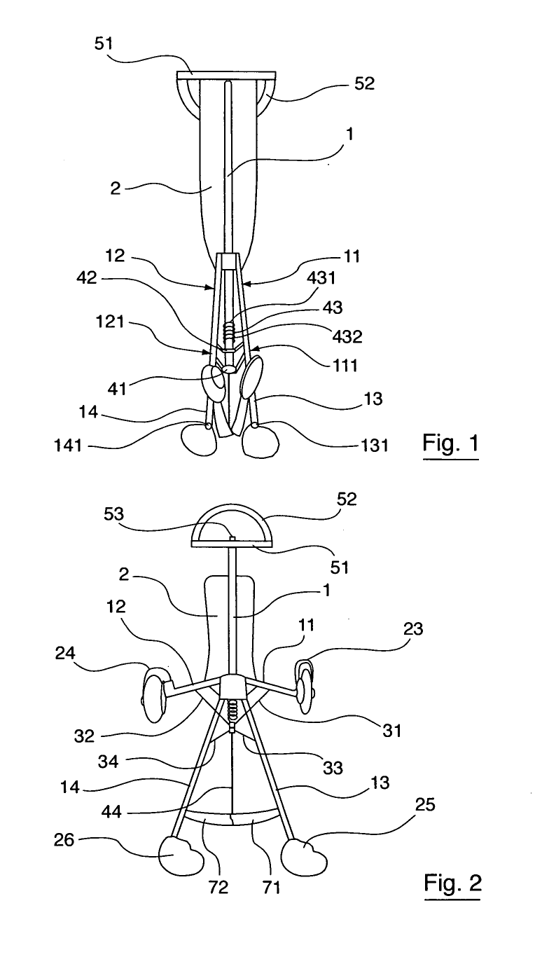

The first embodiment, for example described and shown in FIGS. 1 to 3, relates to a child's carriage with a folding frame of the so-called “umbrella” type fitted with a main beam 1, on which a rigid support structure 2 is mounted free to slide, for example made of plastic, and designed particularly to hold a hammock.

In particular, this rigid structure 2 can be obtained at least partly by moulding, possibly with machining of some portions.

However, the invention is not limited to such structures for which the overall height is constant. Thus, as will be seen later, in a second embodiment, the rigid structure 2 can be replaced by one or several sliding element assemblies.

In the embodiment shown, the frame includes two front arms (also called front legs) 13 and 14 and two back arms 11 and 12 (also called the back legs), for which the lower ends 131, 141, 111 and 121 are fitted with wheel blocks 25, 26, 23 and 24 respectively. For example, each block may support one or two wheels.

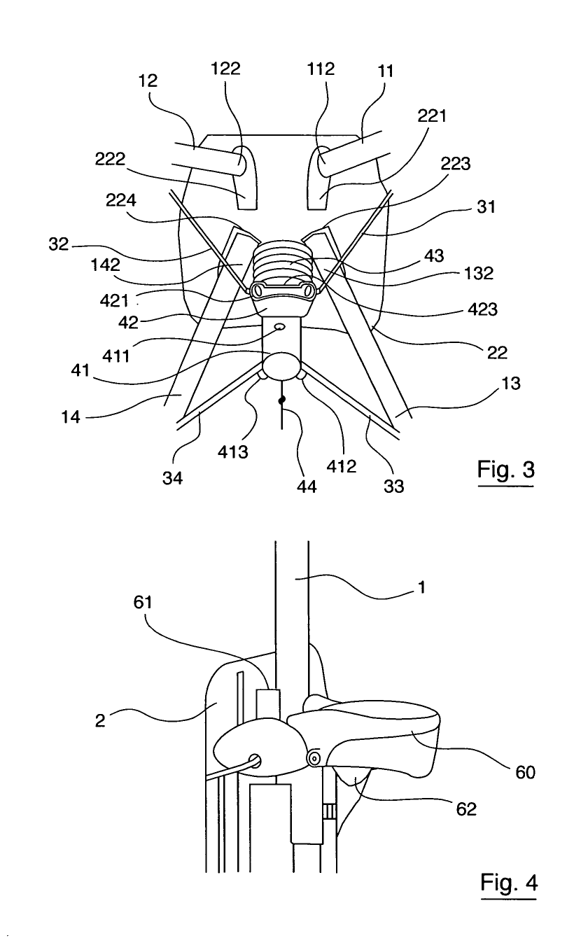

The upper ends 132, 142, 112 and 122 are mounted in pivot connection with the lower part 22 of the rigid structure 2, for example using shouldered screws controlling clamping of parts. As shown in FIG. 3, each upper end is partially housed in a chamber 221, 222, 223 and 224 provided to fix it in the rigid structure 2.

The arms 11, 12, 13 and 14 are designed to be fixed to connecting rods 31, 32, 33 and 34, close to their upper ends. These rods guide the arms from a folded position to an unfolded position and vice versa.

Thus as shown in FIG. 1, in the folded position, the arms form a small angle from the main beam, and in the extended position shown in FIG. 2, the arms form an angle larger than this small angle. In other words in the folded position, the arms are approximately parallel to each other while in the extended position the arms are divergent from each other such that the wheel blocks are positioned at the four corners of a parallelogram approximately defining the overall dimensions of the stroller on the ground. In other words, the angle formed by a connecting rod and the beam is larger in the extended position than in the folded position.

According to the invention, the connecting rods 33 and 34 associated with the front arms are attached to a first articulation element 41 but remain free in rotation, and the connecting rods 31 and 32 associated with the back arm are attached to a second articulation element 42 but remain free in rotation.

This separation of the first and second articulation elements is an important aspect of implementation of the invention.

According to this embodiment of the invention, the first articulation element 41 is fixed to the lower end of the main beam 1, for example using a screw 411 or by insertion. This first articulation element 41 comprises two lugs 412 and 413 with identical shapes, facing the front of the stroller. Each of the lugs is provided with the hole at its centre designed to hold a connecting rod. The lugs 412 and 413 are divergent from each other, such that the connecting rods 33 and 34 form a “V” with a very wide base.

The first articulation element 41 also comprises a latching element (not shown), for example a lug or a bar extending transversely between the lugs 412 and 413, designed to attach a cable 44 to entrain the stroller footrest 7.

The footrest 7 is formed from two parts or pallets 71 and 72 free to pivot with respect to each other. These two pallets are advantageously identical, which simplifies manufacturing. Therefore according to one particular aspect of the invention, a control for this footrest is provided based on the use of a metallic wire 44 installed suspended from the end of the first articulation element 41. The result is thus a simple, efficient, inexpensive and particularly compact mechanism for driving of the footrest. This wire could be replaced by a connecting rod mechanism.

As shown in FIG. 6, two stops 73 and 74, for example made of plastic, are designed to be fixed on the lower face of the footrest. These stops may be in one or two positions: firstly a passive position obtained when the footrest 7 is open in which the stops are arranged crossing each other, and secondly an active position in which the stops are approximately in line with each pallet 71 and 72 of the footrest. The result is a stroller with retractable stabilisation means forming support points in the folded position to support the stroller in a stable vertical position.

Therefore such a stroller according to the invention is particularly suitable for storage in small spaces and in the vertical position. It should be noted that in the active position (stops supported on the ground), each stop coming into contact with the ground applies a force opposite to the opening force of each pallet of the footrest. In other words, the stops oppose opening of the footrest and therefore unfolding of the stroller.

Advantageously, the pallets 71 and 72 can be configured such that when in the folded position, their lower portions act as a support on the ground so as to eliminate the presence of stops.

It should be noted that this approach can easily be adapted to other strollers folding in three dimensions.

It should be noted that according to another possible embodiment, the first articulation element 41 may be installed free to slide along the main beam 1. In this case, another end element, for example a plug, is added. It should be noted that it is also possible to provide two separate parts, one for the lugs on which the connecting rods are fitted and another for the element supporting the footrest control.

The second articulation element 42 is located above the first element 41 and is installed free to slide along the main beam 1. The second articulation element 42 comprises two identically shaped lugs 421 and 422 facing towards the back face of the stroller. Each of the lugs is provided with a hole at its centre designed to hold a connecting rod. The lugs 421 and 422 are divergent from each other such that the connecting rods 31 and 32 form a “V” with a base approximately the same as the base formed by connecting rods 33 and 34.

It should be noted that the pair of front connecting rods 33 and 34 and the pair of back connecting rods 31 and 32 may have different “V” openings. However, in one particular embodiment, an attempt is made to obtain approximately identical “V” openings to make the stroller more stable on the ground. In this case, the wheel blocks are located at the four corners of a “rectangle” substantially defining the overall dimensions of the stroller on the ground.

According to the embodiment shown in FIG. 3, the second articulation element 42 is provided with a duct 423 at its upper end, into which the lower end 431 of a suspension spring 43 is clipped. This assembly slides along the main beam 1.

In the extended position, the upper end 432 of the suspension spring 43 stops in contact with the lower end 22 of the rigid structure 2. In this position, the spring may be compressed so that it simultaneously performs a central suspension function and a compression function for the articulation elements 41 and 42.

It should be noted that in another possible embodiment, the suspension spring 43 may be fixed to the lower end 22 of the rigid structure 2. Without going outside the scope of the invention, it would also be possible to have a suspension spring installed free to slide between the first articulation element 41 and the second articulation element 42. It would also be possible to use other suspension and/or torsion springs located at different positions along the main beam 1, particularly between the lower end of the main beam 1 and the first articulation element 41, or close to the upper end of the main beam 1.

The main beam 1 of the invention is provided with a handlebar 50 with an adjustable inclination, at its upper end. The handlebar 50 is formed from a guide bar 51 extending perpendicular to the axis defined by the length of the main beam 1 and a pusher arm 52, usually “U” shaped, fixed to the ends of the bar 51. The bar 51 is attached, free in rotation, to the upper end of the main beam 1 by means of a connector part 58.

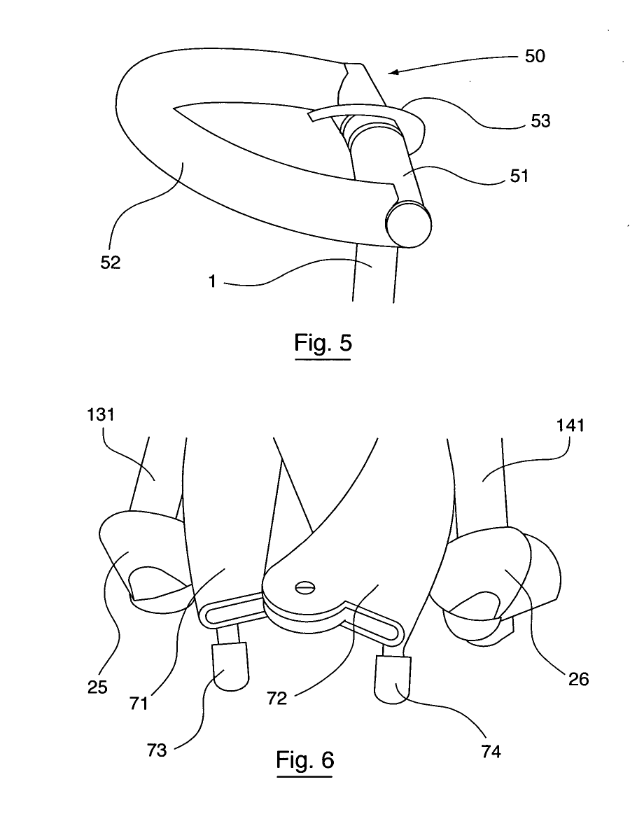

With reference to FIG. 5, the handlebar is advantageously equipped with a cam or a control tab 53 for controlling the inclination of the pusher arm 52. The bar 51 is released in rotation by controlling the control tab 53. The user can thus easily turn the pusher arm 52 about an axis defined by the length of the bar 51, to adjust the inclination of the pusher bar 52 to be comfortable for his or her height, comfortable in use, etc. In other words, the pusher arm 52 may be oriented forwards, backwards, downwards or towards the top of the stroller.

Obviously, variants to the invention could be envisaged, for example on embodiments of the handlebar inclination control mechanism and on how it is installed. In particular, the tab 53 (also called a cam in the remainder of this description) can be replaced or extended by a clutch mechanism.

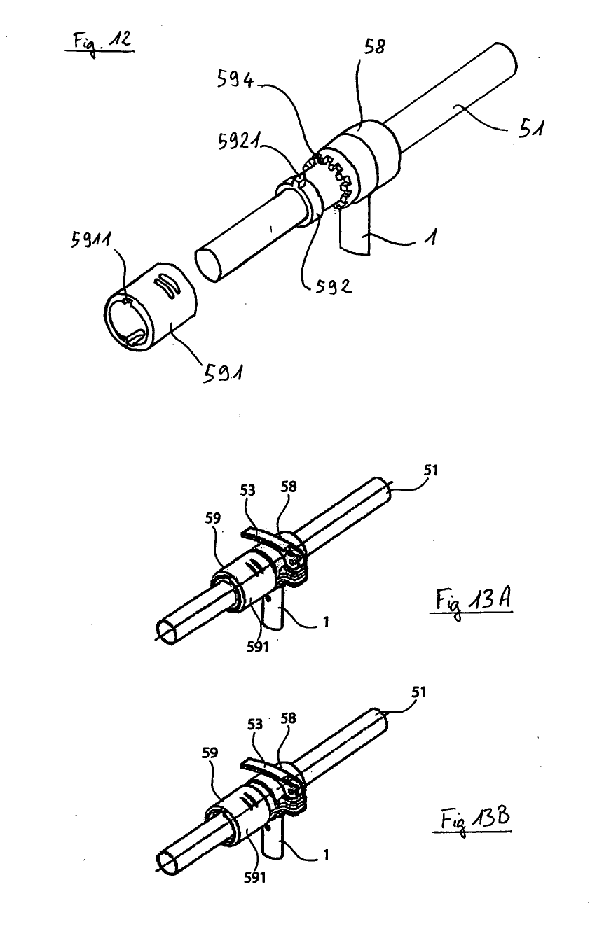

FIG. 12 shows this clutch mechanism applied to a stroller according to the invention. FIGS. 13A and 13B show this mechanism associated with a cam mechanism as described above.

A connector part 58 is fixed to the end of the main beam 1. This connector part 58 comprises an external peripheral toothing 594. The bar 51 on which the pusher arm 52 is fixed is installed free to pivot in this connector part 58. This bar comprises a shoulder 592 on which a pin 5921 is formed.

A pre-emption ring 591 shown separately in FIG. 12 is installed free to slide along the bar 51. The inside of this ring comprises a groove 5911 that cooperates with the pin 5921, such that the ring 591 cannot rotate about the bar 51. This ring 591 also comprises a peripheral toothing (not shown) complementary to the external peripheral toothing 594 of the connector part 58.

FIG. 13A shows a clutch mechanism in which the ring 591 is placed in contact with the connector part 58. In this position, the peripheral toothing of the ring 591 is engaged with the external peripheral toothing 594 of the connector part 58. The bar 51 is then fixed in rotation with respect to the connector part 58. A spring placed under the ring 591 and that bears on the shoulder 592 tends to hold the ring 591 in this position.

On the other hand, when the ring 591 of the connector part 58 is moved slightly away, the user can release rotation of the bar 51 so as to adjust the inclination of the handlebar. This position of the ring 591 away from the connector part 58 is shown in FIG. 13B.

The inventors have observed that the use of a cam or a clutch alone can be insufficient in some cases.

The user might accidentally operate the cam 53 on the handlebar and immediately release rotation of the pusher arm 52.

The stroller can then be used in a situation with reduced safety, since the handlebar can no longer be used for controlled pushing of the stroller.

Furthermore, the coupling between the clutch and the connector part is made by gearteeth which induce play that can result in deteriorated ergonomics and/or usage comfort, depending on their manufacturing tolerances.

Thus, a cam and a clutch can be combined so as to accumulate the advantage of each of these mechanisms and to compensate for their disadvantages.

FIGS. 13A and 13B respectively show a hybrid control mechanism (cam plus clutch) in the locked position (FIG. 13A), in which cam 53 is folded down towards bar 51 and the ring 591 of the clutch is matched to the connector part 58, and in the partially unlocked position (FIG. 13B), in which the cam remains locked and the clutch 59 is moved away from the connector part 58. Obviously, the user simply needs to pull on the cam 53 to completely release the handlebar.

The result is thus a safer control mechanism because the user must trigger a clear release action to release rotation of the handlebar (in other words he must activate firstly the cam and secondly disengage the clutch from the connector part), and is also more comfortable in that when in the locked position, the cam and the clutch are squeezed in contact with each other so as to eliminate clearances between the toothing. In other words, unwanted vibrations at the handlebar are reduced when the stroller is in use. As shown in FIG. 1, in the folded position the pusher arm 52 is folded as far as the front of the stroller, so as to make it more compact.

Also in order to improve the ergonomics and to simplify manipulations necessary for folding/unfolding the stroller, according to one particular aspect of the invention the stroller is provided with a trigger 60 used to control the locking means (not shown) of the main beam 1.

As shown in FIG. 4, the trigger 60 is located close to the upper part 21 of the rigid structure 2. The trigger 60 is designed and installed on the rigid structure 2 so as to define a housing 61, in which the main beam 1 can move. Advantageously, the trigger 60 is provided with a safety button 62 that can authorise actuation of the trigger 60 when it is deactivated. For example, compressing the trigger 60 releases a pin (not shown) inserted in a housing (not shown) provided for this purpose in the main beam 1, through a spring (not shown). In this case (release of the locking means), the user can make the main beam 1 slide along the rigid structure 2, such that if the user pulls on the main beam 1, the arms of the stroller will be extended, and on the other hand if the user pushes on the main beam 1 downwards, the arms of the stroller will be folded.

The locking means (that in this case are active) must obviously slide slightly along the main beam 1 so that the main beam 1 follows the offset due to compression of the spring 43 (in the unfolded position). A slit (not shown) is thus provided in the main beam 1. Advantageously, this slit extends along the length of the beam and enables the locking means to move inside the beam 1.

In one variant of the invention, the main beam 1 may be provided with return means, for example one or several torsion springs tending to bring the handlebar 50 into contact with the upper end 21 of the rigid structure 2. In this case, the user can fold the stroller with one hand, simply by pressing on the trigger and lifting it slightly. Thus, a stroller according to the invention is particularly well suited for mothers with their arms full of shopping or carrying their child in a single arm.

With reference to FIGS. 1 and 2, the connecting rod driving mechanism may be in three different positions: a passive position (FIG. 1) in which the spring 43 is relaxed (the top end of the spring is free) and the first 41 and second 42 articulation elements are remote from each other, an intermediate position (FIG. 2) in which the upper end of the spring 43 stops in contact with the lower end 22 of the rigid structure 2 and the first 41 and second 42 articulation elements are in contact with each other, and an active position (not shown) in which the spring 43 is compressed and the first 41 and second 42 articulation elements are remote from each other. This separation between the first and second articulation elements when the suspension spring is compressed is an important aspect of the embodiment of the invention.

In summary, the invention proposes a new approach to the driving of the connecting rods, in which at least some connecting rods are fixed to a sliding part and not to a fixed part. In particular, this enables the use of a suspension spring.

This suspension spring acts on sliding parts so as to fix them along a main beam. Therefore, this arrangement makes folding and unfolding operations very easy, simply by using the main beam.

In particular, this suspension spring enables a central suspension function.

Obviously, variants of the invention would be possible, particularly on embodiments and implementation of the central suspension. In particular, the spring 43 may be replaced by another type of spring and/or any other appropriate elastic means. Two (or more) springs close to each other could also be combined. It would also be possible to use a spring with two different stiffnesses along its length. It would also be possible to provide adjustment means for varying and controlling the stiffness of the suspension, for example in two predefined positions, by varying the movement of the spring 43. For example, it could be a cam (or any other variable thickness element) compressing the spring more or less, and that is adjusted using a ring.

In yet another variant, the four connecting rods may be installed fixed on the sliding element.

Similarly, it should be noted that the technique according to the invention may be applied in the case of a stroller with three wheels. In this case, the three connecting rods may be mounted fixed on the sliding element or the connecting rod of the front arm may be mounted fixed on a distinct element fixed on the main beam.

It is also possible to make the stroller more compact in the folded position by varying the height of the assembly.

Thus, an articulation formed on the beam can be provided so that the upper part supporting the handlebar can be folded down, for example towards the hammock.

As already mentioned, the invention can also use a frame with a foldable main beam. According to one embodiment, the main beam is free to slide.

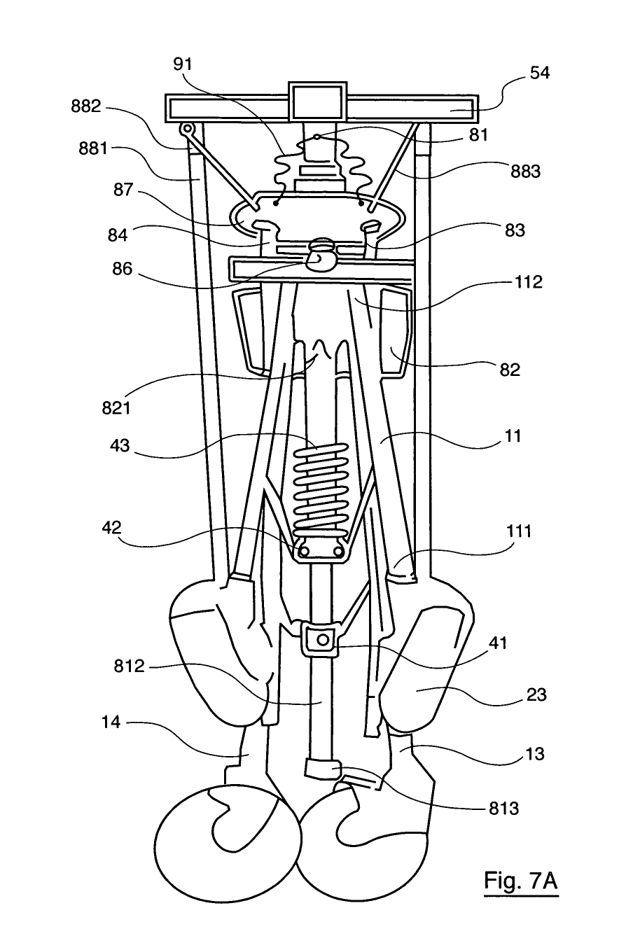

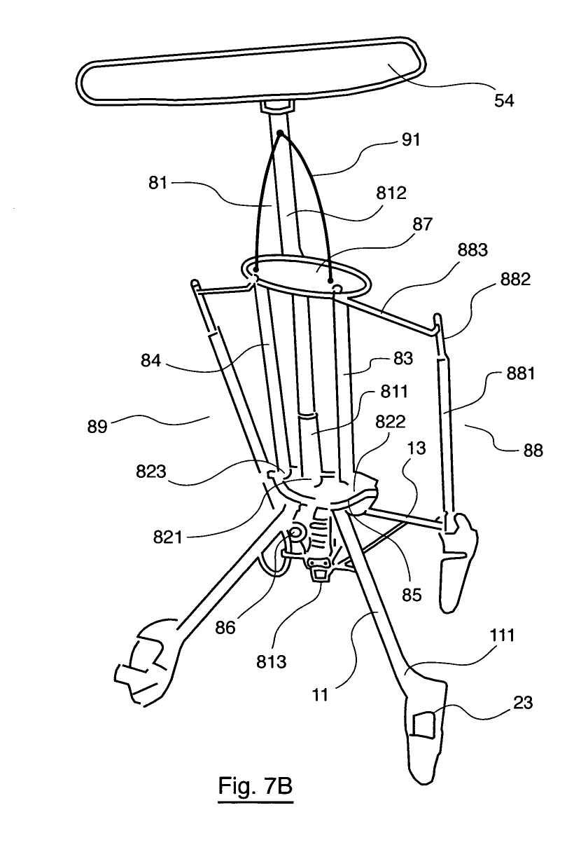

FIGS. 7A and 7B show an example of a folding frame for such a stroller, in the folded and extended positions respectively.

As shown on these figures, the frame comprises a main beam 81 on which an articulation structure 82, for example made of a plastic material, is mounted free to slide and is designed particularly to hold the two front arms 13 and 14 and the two back arms 11 and 12.

A wheel 23 (or a wheel block) is mounted at the lower end 111 of each arm. The upper end 112 of each arm is partially housed in a chamber (not shown) provided for this purpose in the articulation structure 82 so that it is fixed and free to move in rotation.

According to this embodiment of the invention, the main beam 81 is formed from two tubes 811 and 812 sliding with respect to each other. The first tube 811 has a slightly larger radius than the second tube 812, so as to enable a “tube in tube” type sliding.

The first tube 811 is provided with a connecting rod mechanism like that described above with reference to FIGS. 1 and 2, close to its lower end. Remember that this mechanism includes first 41 and second 42 separate articulation elements on which the front connecting rods 33 and 34 and the back connecting rods 31 and 32 respectively are installed. This mechanism also includes a suspension spring 43 performing the central suspension function. The second articulation element 42 and the spring 43 are mounted free to slide along the first tube 811.

The second tube 812, significantly longer than the first tube 811, is provided with a handlebar 54 with an adjustable inclination at its upper end.

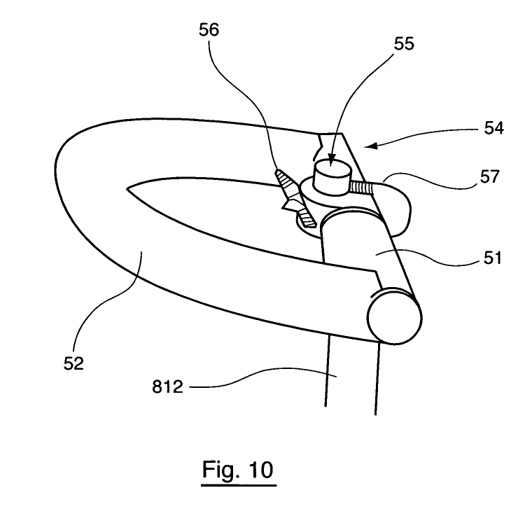

With reference to FIG. 10, the handlebar is advantageously equipped with a tab 57 to control the inclination of the push arm 52. The rotation of the bar 51 is released by pressing the control tab 57.

In the embodiment illustrated, the handlebar 54 is provided with a button 55 controlling the locking means (not shown) of the main beam 81 with respect to the articulation structure 82. Advantageously, the handlebar 54 is fitted with a safety butterfly 56 which, when deactivated, enables activation of the button 55. For example, by pressing on button 55, a locking pin (not shown) housed in a housing provided for this purpose in the articulation structure 82 is released through a rod (not shown).

This tube 812 is provided with a plug 813, for example made of plastic, at its lower end, designed to engage in the lower end of the first tube 811. Thus, this plug 813 closes off the opening at the lower end of the first tube 811, so as to prevent dust from penetrating into it, which can hinder sliding of the second tube 812 in the first tube 811.

The articulation structure 82 according to the invention enables sliding of the main beam 81 in the articulation structure. Therefore, this structure comprises a housing or tunnel 821 close to its centre, in which the first sliding tube 811 can slide. This tunnel 821 is circular in shape and has a radius slightly larger than the first tube 811. Therefore sliding of the first tube 811 in this tunnel 821 causes very little friction.

The folding hammock support is also adapted.

According to the invention, the rigid structure 2 (FIGS. 1 and 2) made of plastic is replaced by two sliding side rails 83 and 84 made from a metallic section, for example an aluminium section.

The side rails 83 and 84 are arranged on each side of the main beam 81 and extend approximately parallel to it, both when in the folded position (FIG. 7A) and when in the extended position (FIG. 7B). These side rails 83 and 84 are designed to be installed free to slide along the articulation structure 82.

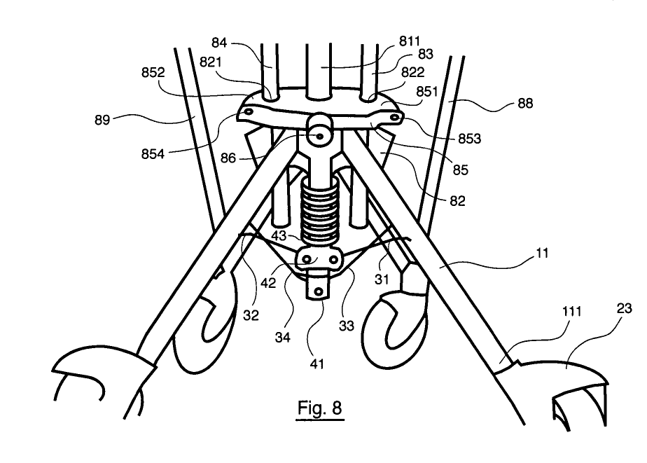

As shown in FIG. 8, the articulation structure 82 comprises a rail 822, usually with a “C” shape, on each side, in which one of the side rails 83 is engaged so that it is guided in sliding. Thus, each side rail slides in contact with a portion of the articulation structure 82, with a radius significantly greater than the radius of the side rail. The small dimensions of the surfaces in contact also result in low friction.

According to one particular aspect of the invention, the frame includes an arc 85, for which the profile is approximately the same as the profile of the upper part of the articulation structure 82 (in other words the part located at the guiderails).

The arc 85 is designed and installed on the articulation structure 82 so as to define housings 851 and 852 inside which the side rails 83 and 84 move. In other words, each of these housings is defined by the space formed between one end of the arc 85 and a rail 822 of the articulation structure 82. The arc 85 is provided with projections 853 and 854 on each side, that are used to make screwed assemblies on the articulation structure 82. Advantageously, the ends of the arc are not in contact with the side rails. Therefore, the presence of this arc can efficiently hold the side rails in their corresponding rails without hindering sliding of the side rails.

Advantageously, the arc 85 is made from a metallic section, for example an aluminium section, and its profile can be obtained for example after bending operations.

In one preferred embodiment of the invention, the arc 85 is provided with a handle 86 controlling displacement of the articulation structure 82 along the main beam 81 and the side rails. As will be seen later, such a handle 86 can improve the ergonomy and simplify manipulations necessary for folding/extending the stroller.

According to this embodiment of the invention, the lower end of each side rail 83 and 84 is free. The upper ends are connected to each other through a hinge part 87, for example made of plastic.

However, it is important that the upper ends of the side rails are held firmly in place. The hinge part 87 is provided with openings 871 and 872 with a shape complementary to the side rails 83 and 84, for this purpose. Thus, an assembly can be made by force fitting, screwing or gluing at each of these openings without hindering sliding of the side rails in the articulated structure 82. In other words, the hinge part 87 simply fits onto the upper ends of the side rails.

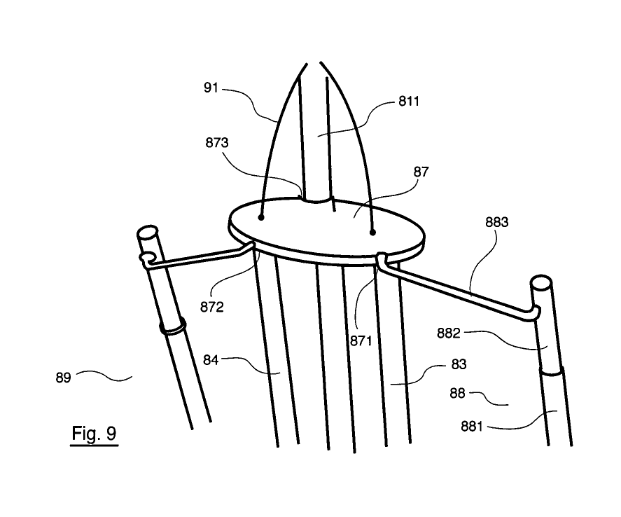

As can be seen in FIG. 9, the hinge part 87 also comprises a housing or tunnel 873 close to its centre, inside which the main beam 81 is free to slide. This tunnel 873 is circular in shape and it has a slightly larger radius than the first tube. Therefore, sliding of the first 811 and second 812 tubes inside this tunnel creates very little friction.

It should be noted that the openings 871, 872 and 873 of the hinge part are directly facing the openings 822, 823 and 821 in the articulation structure 82.

The frame according to the invention also comprises a lateral hammock support formed from two tubular longitudinal members 88 and 89 located on each side of the main beam 81.

Each longitudinal member 88 is formed from two tubes 881 and 882 free to slide relative to each other. The first tube 881 has a slightly larger radius than the second tube 882, so as to enable “tube in tube” type sliding.

According to the embodiment shown in FIG. 7B, the lower ends of the first tubes 881 are mounted articulated close to the lower ends of the front arms 13, for example using connecting rods.

The second tubes 882 are designed to be fixed to connecting rods 883, close to their upper ends. These connecting rods guide the second tubes from a folded position to an extended position, and vice versa.

As shown in FIG. 7A, in the folded position, the upper ends of the second tubes 882 are shorter than the upper ends of the first tubes 881, and in the extended position shown in FIG. 7B, the upper ends of the second tubes 882 are longer than this reduced length. Furthermore, it should be noted that the angle formed between a connecting rod 883 and a longitudinal member 88 is larger in the extended position than in the folded position. Thus in the folded position, the longitudinal members 88 are close to the main beam 81, and in the unfolded position the longitudinal members 88 move away from the main beam 81.

With reference to FIGS. 7A and 7B, the hammock support driving mechanism may be in two positions, firstly a closed position (FIG. 7A) in which the articulation structure 82 and the hinge part 87 are close to each other such that the side rails 83 and 84 and the main beam 81 extend mainly below the articulation structure 82, and an open position (FIG. 7B) in which the articulation structure 82 and the hinge part 87 are separated from each other such that the side rails 83 and 84 and the main beam 81 extend generally between the articulation structure 82 and the hinge part 87.

It should be noted that in the folded position, the lower ends of the side rails 83 and 84 and the main beam 81 remain close to the lower ends of the front and back arms. These ends are neither in contact with the ground nor with the front wheels. Therefore, the side rails and the main beam 81 do not interfere with support points (on the ground) formed by the front wheels. In other words, the side rails and the main beam 81 do not unbalance the stroller when in the upright position. On the contrary, they provide a means of lowering the centre of gravity of the stroller. The result is better stability of the stroller in the upright position.

To fold the stroller according to the invention, the user unlocks the safety locks (in other words turns the safety butterfly nut 56 and presses the button 55), and then pushes on the handlebar 54 so as to bring the said hinge part 87 closer to the articulation structure 82.

During the folding operation, the connecting rods 883 move from a position substantially perpendicular to the longitudinal members 88, towards a position in which the angle between the rods and these longitudinal members is small. This displacement will cause the longitudinal members 88 to move towards the main beam 81 by pivoting around the hinge part 87.

Therefore in the folded position, the stroller has the longitudinal members 88 in contact with the side rails 83 and 84, the side rails and the arms are close to each other and the main beam 81 penetrates into the articulation structure 82 and therefore the stroller is particularly compact.

According to another embodiment, the main beam may be provided with an articulation so that it can be folded on itself.

It should be noted that this approach provides a means of defining two levels of folding: a first simple and fast folding in which the legs are brought alongside the beam which remains unfolded, and a more compact folding requiring the additional operation to fold the beam.

According to one variant of the invention, the articulation structure 82 and the arc 85 can form a single part called the connecting part in the remainder of this description. According to this variant, the invention uses a frame in which the hammock is folded/unfolded using metallic cables. These cables make the hinge part 87 slide with respect to the connecting part.

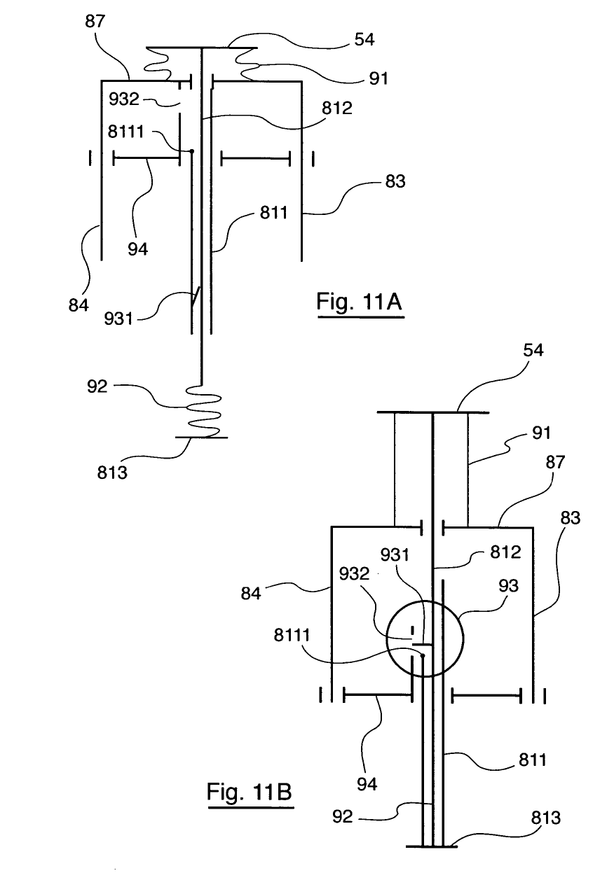

FIGS. 11A and 11B show an example of a folding frame for such a stroller, in the folded and unfolded positions respectively.

As shown in these figures, the hinge part 87 is mounted close to the upper end of the second tube 812, using metallic cables 91. These cables guide the hinge part 87 from a folded position to an unfolded position, and vice versa.

Thus, when the user pulls on the handlebar 54, the hinge part 87 moves away from the connecting part 94 and the side rails 83 and 84 unfold, but on the other hand when the user pushes the handlebar 54 downwards, the hinge part 87 moves closer towards the connecting part 94 and the side rails 83 and 84 fold.

As already mentioned, remote controls of the frame locking device (as described in FIG. 10) are located on the handlebar. According to this embodiment of the invention, when the locking device 93 is active, it provides a means of positioning a fixing pin 931 in a housing 932 formed in the connecting part 94. In this case, the fixing pin connects the second tube 812 to the connecting part 94, so as to prevent folding of the hammock.

This embodiment includes control of the closing plug 813 based on use of a metallic cable 92 installed suspended from the lower end of the second tube 812. As clearly shown in FIG. 11B, when it is in the extended position, the metallic cable 92 increases the effective length of the second tube 812 so that the height of the handlebar is more comfortable in use. The result is a simple, efficient and particularly compact mechanism for entraining closing plugs. This mechanism can reduce the length of the second tube 812 such that when in the folded position, the second tube does not interfere with the support points (on the ground) formed by the front wheels. In other words, the second tube does not touch the ground and does not unbalance the stroller.

1-24. (canceled)

25. A stroller for a child comprising:
at least three blocks of at least one wheel, each mounted at a first end of an arm, the second end of which is articulated and free to slide along a main beam, the arms being guided by at least one connecting rod between a folded position in which they form a small angle with the beam, and an unfolded position in which the arms form an angle larger than the small angle,
at least one sliding element mounted on the beam, to which at least one of the connecting rods is fixed, and
a suspension fixed to the beam and acting on at least one of the sliding elements.

26. The stroller according to claim 25, wherein the suspension comprises a coil spring mounted on the main beam.

27. The stroller according to claim 26, wherein a first end of the coil spring is fixed to one of the sliding elements.

28. The stroller according to claim 26, wherein a second end of the coil spring is free.

29. The stroller according to claim 25, wherein at least a first of the connecting rods is fixed to one of the sliding elements and at least a second of the said connecting rods is fixed to a fixed part installed on a lower end of the beam.

30. The stroller according to claim 29, wherein each connecting rod associated with a rear wheel is a first of the connecting rods and each connecting rod associated with a front wheel is a second of the connecting rods.

31. The stroller according to claim 25 and further comprising a locking pin cooperating with an opening formed in the beam for locking the stroller in the unfolded position.

32. The stroller according to claim 31, wherein the said opening comprises a slit enabling a slight movement along the beam.

33. The stroller according to claim 25, wherein the main beam can be folded to reduce its size in the unfolded position.

34. The stroller according to claim 33, wherein the main beam comprises a first element with a guide for a corresponding second element to slide in or close to the first element.

35. The stroller according to claim 25 wherein it comprises locking means for locking the stroller in the unfolded position and a seat support forming a connection between the locking means and a sliding support of the arms.

36. The stroller according to claim 25, wherein it includes locking means for locking the stroller in the unfolded position and means of controlling the locking means mounted on the beam.

37. The stroller according to claim 35, wherein the said seat support comprises two elements mounted articulated on the sliding support such that they oppose opening of a hammock when they extend below the sliding support.

38. The stroller according to claim 25, wherein it comprises a hammock support formed from two longitudinal members, each formed from two sliding tubes, one sliding inside or relative to the other.

39. The stroller according to claim 38, wherein at least one of the said sliding tubes is guided in sliding by a connecting rod.

40. The stroller according to claim 25, wherein it includes a footrest formed from two articulated pallets.

41. The stroller according to claim 40, wherein unfolding and/or folding of the footrest is controlled by at least one cable and/or at least one of the connecting rods.

42. The stroller according to claim 40, wherein at least one of the pallets supports at least one support element to hold the stroller in an upright position, when it is in the folded position.

43. The stroller according to claim 42, wherein each of the pallets supports a support element, these support elements being mounted such that when they are in contact with the ground, they oppose unfolding of the stroller.

44. The stroller according to claim 25, wherein the main beam is provided with means for guidance of the said stroller at its upper end, articulated with respect to the main beam.

45. The stroller according to claim 44, wherein the guide means comprise second locking means installed articulated on the main beam such that when in and unlocked position, they enable rotation of the guide means around an axis perpendicular to the main beam.

46. The stroller according to claim 44, wherein the guide means comprise third locking means using a clutch mechanism, part of which is fixed to the main beam and another part of which is fixed to the guide means.

47. The stroller according to claim 46, wherein the guide means comprise second locking means installed articulated on the main beam such that when in an unlocked position, they enable rotation of the guide means around an axis perpendicular to the main beam, and wherein the third locking means cooperate with the second locking means to immobilise the guide means with respect to the main beam.

48. A child stroller frame comprising:
at least three blocks of at least one wheel, each mounted at a first end of an arm, the second end of which is articulated and free to slide along a main beam, the arms being guided by at least one connecting rod between a folded position in which they form a small angle with the beam, and an unfolded position in which the arms form an angle larger than the small angle,
at least one sliding element mounted on the said beam, to which at least one of the connecting rods is fixed, and
suspension means fixed to the beam for acting on at least one of the said sliding elements.
